(19) United States
(12) Patent Application Publication
(10) Pub. No.: US 2025/0129518 A1
(43) Pub. Date: Apr. 24, 2025

(54) CORE-SHEATH POLYMER STRAND AND PROCESSES FOR PRODUCING SAME

(71) Applicant: 3DBIOFIBR INC., Halifax (CA)

(72) Inventors: Swomitra PALIT, Sydney (CA); Laurent KREPLAK, Halifax (CA); John Paul FRAMPTON, IV, Halifax (CA)

(73) Assignee: 3DBIOFIBR INC., Halifax, NS (CA)

(21) Appl. No.: 18/690,351

(22) PCT Filed: Jan. 9, 2023
(86) PCT No.: PCT/CA2023/050012

§ 371 Date: Mar. 8, 2024

Related U.S. Application Data
(60) Provisional application No. 63/298,255, filed on Jan. 11, 2022.

(51) Int. Cl. D01D 5/34; C08J 3/07; C08L 5/02; C08L 71/02

(52) U.S. Cl. CPC D01D 5/34; C08J 3/07; C08L 5/02; C08L 71/02; C08J 2303/02; C08J 2471/02; C08L 2203/12; C08L 2207/53; C08L 2312/06; D10B 2331/00; D10B 2331/06

(57) ABSTRACT

A process for producing a core-sheath polymer strand involves inserting a nucleation element through a first pre-strand composition at least partially into a second pre-strand composition. The first pre-strand composition contains a first polymer and the second pre-strand composition contains a second polymer. The nucleation element is then withdrawn from the second pre-strand composition through the first pre-strand composition. The nucleation element is then pulled out of the first pre-strand composition so that a polymer strand having a core of the first polymer encapsulated by a sheath of the second polymer is pulled by the nucleation element out from the pre-strand compositions. The core-sheath polymer may be differentially cross-linked and functional additives may be included in the pre-strand compositions so that the core-sheath polymer contains different functional additives in the core vs. the sheath or different concentrations of the same additive in the core vs. the sheath.

### CROSS-REFERENCE TO RELATED APPLICATIONS

This application claims the benefit of U.S. Provisional Patent Application 63/298,255 filed Jan. 11, 2022, the entire contents of which is herein incorporated by reference.

### FIELD

This application relates to polymer strands and processes for producing polymer strands, especially polymer strands having a core and a sheath around the core.

### BACKGROUND

Polymer micro- and nanofibers with high surface area-to-volume and strength to-weight ratios have a variety of applications and are used for production of conductive materials, protective clothing, components of fuel cells, aerospace materials, filters, components for telecommunication, drug delivery vehicles, tissue engineering scaffolds, smart textiles, and sensors. To impart additional functionalities and thereby expand potential applications of these polymer fibers, multi-component systems such as core-sheath fibers have attracted considerable attention. Perhaps the most widely recognized application for core-sheath fibers is for the controlled release of compounds of interest localized to either the core, the sheath, or both compartments of the core-sheath fiber. The release of compounds encapsulated in the core can be controlled by changing the concentration and chemical composition of both the core and the sheath of the fiber. Others have developed core-sheath fibers in which living cells are encapsulated within the core of the fiber with potential applications in tissue engineering and cell delivery.

Coaxial and emulsion electrospinning are the two most common methods for core-sheath fiber production. Coaxial electrospinning uses a dual capillary spinneret to feed two dissimilar materials such that a coaxially jetting stream is formed. A high voltage applied to the spinneret through which the solutions flow results in a Taylor cone followed by the thinning of the polymer jet induced by the electrostatic potential. The two components in coaxial electrospinning can be two spinnable polymeric solutions or one spinnable polymer solution as the sheath and one non-spinnable Newtonian fluid or powder as the core. Alternatively, emulsion electrospinning requires the simultaneous spinning of two immiscible solutions. In emulsion electrospinning, one polymer is typically dissolved in an organic solvent to form a continuous and easily spinnable phase, while the second polymer is dissolved in water to form an aqueous phase. The dispersed aqueous phase then becomes the core of the electrospun fiber, while the continuous phase becomes the sheath of the fiber. However, both coaxial and emulsion electrospinning can suffer from low reproducibility for certain polymer formulations due to difficulty controlling interfacial and viscoelastic properties of the spin solutions, which can ultimately result in poorly structured fibers. In addition, the electrospinning process involves high voltages and often utilizes harsh solvents to efficiently produce fibers, both of which can damage the encapsulated compounds that give the fibers their advanced functions.

The emulsion electrospinning approach takes advantage of the phase separation between organic solvents and water stabilized by a surfactant/emulsifier. If one could replace electrospinning by other methods such as dry spinning, needle spinning, touch spinning, track spinning, or contact drawing (a form of free surface spinning), then it would become possible to produce core-sheath fibers using water-in-water polymer mixtures also known as aqueous two-phase systems (ATPSs).

There remains a need for a process of producing core-sheath fibers, especially a method that is amenable to processing phase separating polymer solutions into fibers, and to core-sheath fibers obtained by such a method.

### SUMMARY

A process for producing a core-sheath polymer strand comprises: inserting a nucleation element through a first pre-strand composition at least partially into a second pre-strand composition, the first pre-strand composition comprising a first polymer and the second pre-strand composition comprising a second polymer; withdrawing a nucleation element from the second pre-strand composition through the first pre-strand composition; and then, continuing to pull the nucleation element out of the first pre-strand composition so that a polymer strand comprising a core of the first polymer encapsulated by a sheath of the second polymer is pulled by the nucleation element out from the pre-strand compositions.

A core-sheath polymer strand comprises a core comprising a first polymer encapsulated by a sheath comprising a second polymer, wherein: the first polymer is cross-linked and has a first functional additive entrained therewith; the second polymer is cross-linked and has a second functional additive entrained therewith; and, the first functional additive is the same as the second functional additive but the first functional additive is entrained with the first polymer in a concentration that is different than a concentration of the second functional additive entrained with the second polymer, or the first functional additive is different from the second functional additive.

The process permits differential cross-linking of the first (core) polymer and the second (sheath) polymer so that the time-release properties between the core and the sheath can be different. Thus, functional additives added to the first and second pre-strand compositions and then entrained in the core and the sheath can be released at different times, which is especially useful for controlled release of functional additives (e.g., pharmaceutically active agents), especially two different additives.

The process for producing a core-sheath polymer strand provides other important advantages over other core-shell techniques. For example, the process described herein provides control over strand diameter to permit the production of strands having diameters in a range of 1-100 microns. Standard coextrusion creates core-shell strands with 100-200 microns in diameter. Electrospinning techniques produce strands having diameters of 100 nm or less. The process described herein can thus unlock the intermediary scale from 1-100 microns, which is important for molecular interactions with functional additives. Also, the process may remove the need for emulsifiers as well as high-pressure mechanical mixing or ultrasonic homogenization, both of which might affect the structure and function of compounds encapsulated in the strands. This process is both versatile and easy to scale, offering a tunable approach for the fabrication of functional core-sheath polymer strands for numerous applications.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a schematic diagram of a horizontal contact drawing system used to pull dextran-PEO core-sheath polymer strands from a liquid reservoir containing an aqueous two-phase system (ATPS) of dextran and polyethylene oxide (PEO).

FIG. 2A depicts a graph of strand failure rate (%) as a function of Tpull(s) for a polymer solution having 10% wt PEO in water and a polymer solution having 50% wt dextran in water. Each data point is the failure rate calculated from 20 trials and each data set is fit using a Weibull cumulative distribution function (shown in dashed lines).

FIG. 2B depicts a graph of strand failure rate (%) as a function of Tpull(s) together with a fitted data curve using a Weibull cumulative distribution function for a core-sheath polymer solution having 10% wt PEO and 50% wt dextran in water. Failure plots for fibers formed from either a solution of 10% wt PEO or 50% wt dextran in water are shown for reference.

FIG. 3 depicts Dextran-PEO fluid dynamics during a contact drawing process. (A) Proposed mechanism for core-sheath strand production from immiscible aqueous solutions of dextran and PEO, where dextran is placed at the front of reservoir and PEO is placed at the back of the reservoir. (B) A single frame from a 60 frame/s video after needle withdrawal, showing the needle path into the PEO phase, the phase separation interface between the dextran and PEO phases, and the presence of a cone-like structure in the dextran phase. (C) Movement of the microneedle through the reservoir containing dextran and PEO. Scale bars in (B) and (C) are approximately 500 μm.

FIG. 4 depicts the path of a microneedle through the reservoir (captured after withdrawal) during the contact drawing process depicted in FIG. 3. The deflection of the dextran-PEO interface is visible in the bulk PEO phase several minutes after microneedle withdrawal.

FIG. 5A depicts an image of a spin cone formed by the PEO in the contact drawing process of FIG. 3 when a PEO sheath is drawn from the PEO phase into the dextran phase. The direction of pull is toward the right in the image.

FIG. 5B depicts an image of a spin cone formed by the dextran in the contact drawing process of FIG. 3 when a dextran core is drawn from the dextran phase into air. The direction of pull is toward the right in the image.

FIG. 6 depicts epifluorescence images of strands formed from the dextran-PEO interface. The localization of FITC-dextran and pyrene-PEG-rhodamine supports a core-sheath structure when the dextran solution is placed at the front of the reservoir and the PEO solution is placed at the back of the reservoir (left panel). A thin strand with discontinuous FITC-dextran and pyrene-PEG-rhodamine signal is formed when the PEO solution is placed at the front of the reservoir and the dextran solution is placed at the back of the reservoir (right panel).

FIG. 7 depicts PEO-Dextran fluid dynamics during a contact drawing process, where the dextran solution is placed at the back of the reservoir and the PEO solution is placed at the front of the reservoir. (A) Proposed mechanism for strand formation. (B) A single frame from a 60 frame/s video after microneedle withdrawal, showing the expected microneedle path into the dextran phase, the phase separation interface between the dextran and PEO phases, and the presence of a cone-like structure in the PEO phase. (C) Movement of the microneedle through the reservoir containing PEO and dextran. Scale bars in (B) and (C) are approximately 500 μm.

FIG. 8 depicts images of the localization of dextran and PEO phases after microneedle withdrawal in the contact drawing process of FIG. 7.

FIG. 9 depicts fluid dynamics of spin cones extending from the surface of the fluid in the reservoir in the process of FIG. 3. (A) Representative images of spin cones formed from 50% wt dextran and (B) the associated radius decay plot. (C) Representative images of spin cones formed from 10% wt PEO and (D) the associated radius decay plot. (E) Representative images of spin cones formed from an ATPS of 50% wt dextran and 10% wt PEO and (F) the associated radius decay plot. The time of t=0 is defined as the time at which the needle has started moving from the polymer reservoir. In all cases, the pull length is 100 mm and the pull speed is 400 mm/s. R is the final radius and R₀ is the initial radius.

FIG. 10 depicts Attenuated Total Reflectance Fourier Transform Infrared (ATR-FTIR) spectra of strands formed from PEO, dextran and a dextran-PEO ATPS. (A) 2% pressure and (B) 30% pressure.

FIG. 11 illustrates that core diameter scales with dextran concentration. (A) Representative optical section from confocal microscopy from 10% wt PEO (tracked using pyrene-PEG-rhodamine) and either 52% wt dextran or 60% wt dextran (tracked with FITC-dextran). Scale bars are 50 μm. (B) Diameter of the core for a 100 mm long core-sheath strand for various dextran concentrations. Data points are mean values±standard deviation fit with a second order polynomial function.

FIG. 12 depicts optical images of strands formed from either two solutions of dextran or two solutions of PEO of varying concentration and viscosity. Scale bars are 50 μm.

FIG. 13 depicts microscope images of PEO strands cross-linked in the presence of 25% wt 0% wt or 5% wt PEGDA with 2% wt Irgacure™ 2959 as a photoinitiator and irradiated with UVC radiation at an intensity of 400 mJ/cm² or 0 mJ/cm², before hydration with PBS buffer and 1 hour after hydration with PBS buffer. Scale bars are 10 μm.

FIG. 14 depicts microscope images of dextran strands cross-linked in the presence of 10% wt or 5% wt or 2.5% wt photodextran (PhDex) with 2% wt Irgacure™ 2959 as a photoinitiator and irradiated with UVC radiation at an intensity of 400 mJ/cm² or 0 mJ/cm², before hydration with PBS buffer and 1 hour after hydration with PBS buffer. Scale bars are μm.

FIG. 15 depicts microscope images of PEO and dextran strands cross-linked in the presence of 0% wt PEGDA and 0% wt photo-dextran without Irgacure™ 2959 as a photoinitiator and irradiated with UVC radiation at an intensity of 400 mJ/cm² or 0 mJ/cm², before hydration with PBS buffer and 1 hour after hydration with PBS buffer. Scale bars are 10 μm.

### DETAILED DESCRIPTION

The process involves first inserting a nucleation element through a first pre-strand composition comprising a first polymer. During the passage of the nucleation element through the first pre-strand composition, the first polymer adheres to the nucleation element. As the nucleation element protrudes into the second pre-strand composition, the first polymer remains adhered to the nucleation element. In a preferred embodiment, the first pre-strand composition is immiscible in the second pre-strand composition and the first pre-strand composition is in contact with the second pre-strand composition at a phase separation interface. In the preferred embodiment, the nucleation element does not penetrate the phase separation interface when protruding into the second pre-strand composition, but instead deflects the phase separation interface into the second pre-strand composition.

The nucleation element is then withdrawn from the second pre-strand composition. As the nucleation element is withdrawn from the second pre-strand composition, the separation phase interface becomes undeflected. As an end of the nucleation element passes from the second pre-strand composition into the first pre-strand composition through the initial position of the phase separation interface a negative pressure is created that deflects the phase separation interface into the first pre-strand composition, locally rupturing the phase separation interface allowing the second polymer to be drawn into and through the first pre-strand composition. Continuing to withdraw the nucleation element out of the first pre-strand composition produces a liquid bridge at an interface between the first pre-strand composition and an outside environment (e.g., the air). A polymer strand is drawn from the liquid bridge as the nucleation element continues to be withdrawn. The polymer strand so produced comprises a core of the first polymer encapsulated by a sheath of the second polymer. The second polymer is initially drawn through the first pre-strand composition as a thin-walled cone due to the rupture of the phase separation interface; however, the cone is a transient structure that disappears once the liquid bridge forms at the interface between the first pre-strand composition and the outside environment.

The first pre-strand composition is preferably immiscible in the second pre-strand composition to provide a phase separation interface between the two pre-strand compositions when the two pre-strand compositions are in contact with each other. Surface tension between the first and second pre-strand compositions at the phase separation interface helps reduce diffusion of components between the pre-strand compositions. The second pre-strand composition preferably has a higher zero-shear viscosity than the first pre-strand composition to allow the transient cone of second pre-strand composition to survive within the first pre-strand composition while the liquid bridge is being established. If the less viscous pre-strand composition is used as the second pre-strand composition (i.e., ‘in the back’), the second pre-strand composition may relax prematurely causing strand formation failure. The negative pressure created is different than the positive pressure used in other core-shell methods such as co-extrusion. In the positive pressure methods, the more viscous phase forms the core of the strand, whereas in the process disclosed herein, the more viscous phase can form the sheath. It is therefore surprising that the pre-strand composition in the back can form the sheath of the strand, whereas the pre-strand composition ‘in the front’ can form the core of the strand. Thus, in a preferred embodiment, the nucleation element is inserted through the less viscous pre-strand composition before being inserted into the more viscous pre-strand composition, and the nucleation element is withdrawn out of the less viscous pre-strand composition after being withdrawn out of the more viscous pre-strand composition.

The first and second pre-strand compositions comprise respective first and second polymers. The first and second polymers may be the same or different, but are preferably different polymers. When the first and second polymers are different, the first polymer may be immiscible in the second polymer, thereby rendering the first pre-strand composition immiscible in the second pre-strand composition. The first and second polymers are any polymers that are capable of independently forming polymer strands when withdrawn by the nucleation element from the pre-strand compositions. Polymers include, for example, polysaccharides, polypeptides, polynucleotides, polyolefins, polyvinylics, polystyrenics, polyacrylonitriles, polyacrylics, polyamides, polyesters, polycarbonates, polysulfones, polyimides, polyethylene oxides, polyketones, fluoropolymers, polysilicones and the like as well as cross-linked polymers thereof and copolymers thereof.

Some specific examples of polymers are alginic acid, amylopectin, bovine serum albumin, carageenan, carboxymethyl cellulose, carboxymethyl dextran, casein, chitosan, chondroitin sulfate, collagen (e.g., Type I collagen), dextran, dextran sulfate, diethylaminoethyl dextran, fetal bovine serum, gelatin, guar gum, gum arabic, gum ghatti, hyaluronic acid, hydroxyethyl cellulose, hydroxyethyl starch, hydroxypropyl cellulose, hydroxypropyl methylcellulose, lignin, methyl cellulose, mucin, pectin, peptone, poloxamer 407, poly(2-acrylamido-2-methyl-1-propanesulfonic acid), poly(2-ethyl-2-oxazoline), polyethylene oxide, poly(4-styrenesulfonic acid), poly(4-styrenesulfonic acid-co-maleic acid), poly [bis(2-chloroethyl) ether-alt-1,3-bis [3-(dimethylamino) propyl] urea] quaternized, poly-(α,β)-DL-aspartic acid, poly-D-lysine, poly(acrylamide), poly(acrylic acid), poly(allylamine), poly(diallyldimethyl ammonium chloride), poly(ethylene glycol), poly(ethylene glycol) diacrylate, poly(ethylenimine), poly(methacrylic acid), poly(methyl vinyl ether-alt-maleic acid), poly(N-isopropylacrylamide), poly(propylene glycol), poly(sucrose), poly(vinyl alcohol), poly(vinylpyrrolidone), poly(vinylsulfonic acid), polyoxyethylene (9) nonylphenylether, polyoxyethylene (20) sorbitan monolaurate, polyoxyethylene (23) lauryl ether, pullulans, silks (e.g., spider silk, Bombyx mori silk, other insect silks), tragacanth and xanthan gum.

The pre-strand compositions may comprise further components such as respective liquid media, respective cross-linking agents, respective functional additives or any other component useful for strand formation.

The first pre-strand composition preferably comprises a first liquid medium within which the first polymer is dispersed. The second pre-strand composition preferably comprises a second liquid medium within which the second polymer is dispersed. The first and second liquid media may be the same or different. When the liquid media are the same, immiscibility of the first and second polymers may impart immiscibility of the first and second pre-strand compositions. However, when the first and second polymers are the same or are miscible in each other (i.e., non-phase separating polymers), immiscibility of the first and second liquid media can be used to impart immiscibility between the first and second pre-strand compositions so that the phase separation interface is formed where the first and second pre-strand compositions are in contact.

Utilizing polymers that are immiscible with each other and utilizing liquid media that are immiscible with each other could further enhance phase separation between the first and second pre-strand compositions providing an even more clearly defined phase separation interface between the two pre-strand compositions when the two pre-strand compositions are in contact with each other. A physical barrier between the first and second pre-strand compositions along with a means for allowing the nucleation element to enter and exit the first and second pre-strand compositions could also be utilized.

For each of the first and second pre-strand compositions, the liquid medium, when used, is suitable for dispersing the polymer therein. Preferably, the liquid medium is a solvent capable of dissolving the polymer. The liquid medium may be an aqueous medium or an organic medium or a mixture thereof. Aqueous media include, for example, pure water, buffer solutions, saline solutions, other salt solutions or any other water-based solution. Organic media may comprise an organic solvent, for example aliphatic solvents (e.g., pentanes, hexanes, chloroform, dichloromethane and the like), aromatic solvents (e.g., toluene, aniline and the like), alcohols, ethers, ketones, organic sulfoxides or mixtures thereof. Aqueous media are particularly important when producing core-sheath strands for use in in pharmaceutical applications, for example, controlled release of pharmaceutically active agents or precursors thereof. In some embodiments, the first and second liquid media are both aqueous media.

To enhance structural integrity, stability and solubility resistance of the core and/or the sheath, the first and/or second polymer may be cross-linked polymers before the strand is formed, as the core-sheath polymer strand is formed or after the strand is formed. In some embodiments, the process comprises cross-linking the first polymer, the second polymer or both the first and second polymers before the strand is formed, as the strand is formed or after the strand is formed. Cross-linking can be accomplished in a number of ways including the inclusion of chemical cross-linking agents in the first pre-strand composition, the second pre-strand composition or both the first and second pre-strand compositions. Alternatively or additionally, the cross-linking agent may be electromagnetic radiation, for example ultraviolet (UV) light, alone or together with an initiator (e.g., a photoinitiator such as benzophenone, 1-[4-(2-hydoxyethoxy)-phenyl]-2-hydroxy-2-methyl-1-propane-1-one, etc.). The nature of the cross-linking agent depends to some extent in the nature of the polymer being cross-linked, the desired level of structural integrity for the core and the sheath, and the end use of the core-sheath strand.

Some examples of chemical cross-linking agents include 1-ethyl-3-(3-dimethylaminopropyl) carbodiimide (EDC), an aldehyde (e.g., glyoxal, formaldehyde, glutaraldehyde), an acrylate (e.g., polyethylene glycol diacrylate (PEGDA), photo-dextran (i.e., methacrylated dextran), etc.), a free radical generating cross-linking agent (e.g., a peroxide, such as 2,5-bis(tert-butylperoxy)-2,5-dimethylhexane), an ionic cross-linking agent, a disulfide, amino acid diamines (e.g., lysine, lysine methyl ester, and cystine dimethyl ester), borax to provide cross-linking through hydrogen bonding, other reversible cross-linking agents, thermosetting to provide physical cross-links (e.g., for gelatin, agarose, Matrigel™ and the like) or combinations thereof.

In some embodiments, the first polymer is cross-linked to a different extent than the second polymer to provide differential cross-linking of the core and sheath. Differential cross-linking of the core and the sheath of the core-sheath strand to provide differential control of the structural integrity, stability and solubility resistance of the core and sheath is particularly useful for producing controlled time release materials in which the timing is tuned for a particular purpose. In differential cross-linking, the core (first polymer) and sheath (second polymer) are cross-linked to different extents so that the relative time to dissolution of the core vs. the sheath in a particular environment (e.g., the aqueous environment in a body) can be tuned. Differences in dissolution time of the core vs. the sheath can be used to differentially control the timing of the release of functional additives in the core vs. functional additives in the sheath. This is particularly useful in timed drug release applications. In some embodiments, the first and second pre-strand compositions may each comprise a chemical cross-linker, which are activated after strand formation. By controlling the concentration of the cross-linker in each pre-strand composition, a different degree of cross-linking can be achieved in the core vs. the sheath, which is useful in controlling the timed release of functional additives entrained with the core and the sheath.

To obtain differential cross-linking between the core and the sheath, any of a number of strategies could be employed. For example, cross-linking agents may be added to the first and/or second pre-strand composition, where the concentration of the cross-linking agent in each pre-strand composition is controlled to provide the desired level of cross-linking. Further, click chemistries could be used as fast reactions with one step reactions for cross-linking. In another strategy, polyethylene glycol-acrylate (PEG-acrylate) or other acrylated polymers could be used as scaffolding polymers in which the degree of substitution of PEG-acrylate can be controlled where a higher degree of substitution would lead to higher cross-linking. In another strategy, the core-sheath strand may be formed in air containing an active cross-linker for the sheath in the vapor phase allowing cross-linking of only the sheath. Further, pH and/or temperature of the first and second pre-strand composition may be differentially controlled to provide differential cross-linking. Furthermore, when radiation (e.g., UV light) is used in cross-linking, the sheath could be produced from a pre-strand composition containing an opaque material so that the radiation used for cross-linking does not penetrate to the core. Also, when radiation is used in cross-linking, a photosensitizer and/or a quenching agent could be selectively utilized in the pre-strand compositions to control the extent of cross-linking. When ionic cross-linking is used, adding a chelating agent to one or both of the pre-strand composition can provide differential cross-linking of the core and sheath.

One or both of the first and second pre-strand compositions may comprise one or more functional additives. The first pre-strand composition may comprise one or more first functional additives. The second pre-strand composition may comprise one or more second functional additives. The one or more functional additives may be any chemical or physical entity or combination of chemical and/or physical entities for a desired purpose. The one or more functional additives are thus incorporated into the core or the sheath of the core-sheath strand depending on which pre-strand composition contains the functional additives. Surface tension between the immiscible first and second pre-strand compositions at the phase separation interface, differential affinity of the functional additives to the first and second pre-strand compositions and partitioning to the interface all help reduce diffusion of the functional additives between the pre-strand compositions. This is important when creating a core-sheath geometry with different functional additives and/or different concentrations of the functional additives in the core vs. the sheath, and allows for applications of dual controlled release. Thus, it is possible to simultaneous incorporate different functional additives into the core and sheath of the strand while the strand is being formed. It is also possible to simultaneously incorporate different concentrations of the same or different functional additives into the core and sheath of the strand while the strand is being formed.

The core-sheath strands created in the process, especially those in which the core and the sheath are differentially cross-linked, are advantageously useful in controlled or time release materials whereby the one or more functional additives may be released in a controllable or timed manner over time as the sheath is dissolved to release the second functional additives entrained with the sheath, followed at a later time by dissolution of the core to release the first functional additives entrained with the core. In embodiments where the first and second functional additives are the same chemical or physical entity, the core-sheath strands can be used to controllably release different concentrations of the functional additives over time. Thus, both the core and the sheath can act as time-release vehicles for their respective functional additives, where the time-release properties between the core and the sheath can be different.

Some examples of functional additives include saccharides, growth factors, hormones, extracellular matrix proteins (ECM) (e.g., collagen (e.g., Type I collagen), fibronectin, laminin, etc.), enzymes, cytokines, chemokines, antibodies (e.g., monoclonal antibodies), anti-inflammatoiresteroids, immune suppressants, chemotherapy agents, lipids, hyaluronic acid, liposomes, micro/nano capsules, genetic materials (e.g., DNA (e.g., plasmids), RNA (e.g., mRNA, interfering RNA)), extracellular vesicles, whole cells, metallic ions, non-metallic ions, nanoparticles (e.g., carbon nanotubes, metallic nanoparticles), solid microparticles (e.g., metal, plastics, glass, etc.), colorants, surfactants, detergents, vitamins, bases, mineral and organic acids (e.g., citric acid), other natural health products, other small molecule pharmaceuticals (e.g., minocycline, riluzole, dalfampridine, escitalopram, deoxygedunin, 7,8-dihydroxflavone, quercetin, dexamethasone, tacrolimus) and combinations thereof. The functional additives are preferably pharmaceutically active agents, precursors of pharmaceutically active agents or combinations thereof, especially those which are soluble in aqueous media.

The rate at which the nucleation element is withdrawn can affect the length and thickness of the polymer strand that is produced in the process. Preferably, the nucleation element is withdrawn at a rate such that a pull time (τₚᵤₗₗ) of the nucleation element is less than a first reptation time (τᵣₑₚ1) required to relax polymer entanglements in the first pre-strand composition, thereby inducing a viscoelastic response in the first pre-strand composition as the polymer strand is pulled by the nucleation element. Preferably, the pull time (τₚᵤₗₗ) is also less than a second reptation time (τᵣₑₚ2) required to relax polymer entanglements in the second pre-strand composition, thereby inducing a viscoelastic response in the second pre-strand composition as the polymer strand is pulled by the nucleation element.

Reptation time (τᵣₑₚ) of a polymer in a pre-strand composition is the time required to relax polymer chain entanglements in the pre-strand composition. The reptation time is as long as possible to be able to increase pull time, and should be less than the desired pull time. The reptation time is preferably at least 0.01 second, more preferably at least 1 second. The reptation is preferably in a range of 1 second to 1,000 seconds. In some embodiments, the reptation time is in a range of 1 second to 100 seconds. In other embodiments, the reptation time is in a range of 1 second to 10 seconds.

Pull time (τₚᵤₗₗ) of the nucleation element from the pre-strand compositions is defined as τₚᵤₗₗ=path length/pull rate, where path length is a set distance over which the nucleation element will pull the polymer strand and pull rate is the speed at which the nucleation element will pull the strand over the set distance. Pull time (τₚᵤₗₗ) can instead be defined in relation to the strand instead of the nucleation element, where pull time (τₚᵤₗₗ) of the strand from the pre-strand compositions is defined as τₚᵤₗₗ=length of strand/pull rate, where length of strand is a set length to which the polymer strand is pulled and pull rate is the speed that the strand is pulled over that length. Pull time (τₚᵤₗₗ) of the strand is the same as τₚᵤₗₗ of the nucleation element when the strand is connected to the nucleation element. Defining τₚᵤₗₗ in relation to the strand is useful when the strand is transferred from the nucleation element to a strand winding mechanism, which is preferable in a continuous strand forming process.

In the process, the pull time of the nucleation element (or the strand when the strand is not connected to the nucleation element) is preferably less than the reptation time (τᵣₑₚ) of both of the polymers. Having a pull time less than the reptation time (τᵣₑₚ) of the polymers induces a viscoelastic response in the pre-strand compositions as the strand of the polymers is pulled from the pre-strand compositions. Therefore, at pull times shorter than the reptation times, entanglements act as temporary cross-links and a viscoelastic response occurs thereby permitting the polymer strand to be pulled from the pre-strand compositions without breaking. However, if the interaction time of the nucleation element or an already forming strand with entangled polymers in the pre-strand compositions is greater than the reptation time, entanglements are abandoned and the strand breaks. The pull time is preferably selected to maximize the length of the strand for the desired pull rate. The pull rate is preferably in a range of 0.1-4 m/s, or 0.5-4 m/s, or 0.5-3 m/s or 0.5-2 m/s.

Further, concentration of the polymers in their respective pre-strand compositions can affect strand formation. Preferably, the first polymer has a concentration in the first pre-strand composition that is greater than or equal to a first overlap concentration (c*1) of the first polymer in the first pre-strand composition. The concentration of the first polymer in the first pre-strand composition is more preferably greater than or equal to a first entanglement concentration (Cₑ2) of the first polymer in the first pre-strand composition. Preferably, the second polymer has a concentration in the second pre-strand composition that is greater than or equal to a second overlap concentration (c*2) of the second polymer in the second pre-strand composition. The concentration of the second polymer in the second pre-strand composition is more preferably greater than or equal to a second entanglement concentration (Cₑ1) of the second polymer in the second pre-strand composition.

Overlap concentration (c*) of a polymer in a pre-strand composition is the minimum concentration of the polymer in the pre-strand composition where conformations of individual polymer chains start to overlap each other. This is the point where the concentration within a given pervaded volume is equal to the concentration of the polymer in the pre-strand composition. The concentration of the polymer in the pre-strand composition is greater than or equal to the overlap concentration.

Entanglement concentration (Cₑ) of a polymer in a pre-strand composition is the concentration of the polymer in the pre-strand composition where individual polymer chains start to entangle with each other. The entanglement concentration is always at least as high as the overlap concentration but can be up to as much as 1000 times greater than the overlap concentration. The entanglement concentration is often at least 10 times greater than the overlap concentration. The concentration of the polymer in the pre-strand composition is preferably greater than or equal to the entanglement concentration. Preferably, concentration of the polymer in the pre-strand composition is sufficiently high such that the entire pre-strand composition is in the entangled regime.

The concentration of the polymer in a pre-strand composition is preferably at least 0.01 wt %, more preferably in a range of 0.01 wt % to 99 wt %, based on total weight of the pre-strand composition. The required concentration of the polymer depends to some extent on the molecular weight (Mw) of the polymer. In general, lower concentration is required for polymers with higher molecular weight. The polymer preferably has a molecular weight (Mw) of 1 kDa or more, or 5 kDa or more, or 10 kDa or more, or 35 kDa or more, or 40 kDa or more, or 50 kDa or more, or 70 kDa or more, or 100 kDa or more, or 1,000 kDa or more, or 8,000 kDa or more. In some embodiments, the polymer has a molecular weight (Mw) of 20,000 kDa or less.

The rate of withdrawal of the nucleation element and the concentration of the polymers in the pre-strand compositions is further discussed in International Patent Application PCT/CA2021/051110 filed Aug. 12, 2021, the entire contents of which is herein incorporated by reference.

Bulk viscosity of the pre-strand compositions can be tailored to control strand diameter as lower bulk viscosity leads to thinner strands. As the bulk viscosities of the pre-strand compositions are increased, thicker strands can be formed. However, if the viscosities of the pre-strand compositions are too low, the spin cone collapses breaking the growing strand, and if the viscosities are too high, the negative pressure induced by the moving nucleation element will not be sufficient to allow strand formation. Therefore, it is important to properly set the viscosities of the pre-strand compositions. In some embodiments, the bulk viscosities of the pre-strand compositions are preferably in a range of 8-100 Pas (8,000 cP to 100,000 cP), as measured by a vertical falling ball method. In other embodiments, the bulk viscosities of the pre-strand compositions are preferably in a range of 100-5,000 Pas (100,000-5,000,000 cp), more preferably 100-1,000 Pas (100,000-1,000,000 cp), even more preferably 100-400 Pa·s, yet more preferably 150-300 Pa's, and yet even more preferably 175-250 Pa·s, for example 200 Pa·s, as measured with a StressTech™ HR rheometer.

Bulk viscosity of a pre-strand composition is affected by the concentration of the polymer in the pre-strand composition. Raising the concentration of the polymer in the pre-strand composition increases the bulk viscosity while lowering the concentration decreases the bulk viscosity. Tailoring the concentrations of the polymers in the pre-strand compositions therefore tailors the diameter of the strand produced. The diameter of the strand produced can also be tailored by controlling the rate of withdrawal of the nucleation element, whereby higher speeds provide strands with smaller diameters. The rate of withdrawal of the nucleation element is preferably in a range of 0.1-4 m/s, or 0.5-4 m/s, or 0.5-3 m/s or 0.5-2 m/s. Average strand diameters in a range of 20-1,000,000 nm can be achieved by appropriate tailoring of the viscosities of the pre-strand compositions and the rate of withdrawal of the nucleation element.

The nucleation element may be any object on which the strand can nucleate when the element is inserted into the pre-strand compositions. Nucleation of the strand results in adherence of some of each of the pre-strand compositions, for example in the form of a drop, at one or more nucleation sites on the nucleation element. As the nucleation element is withdrawn from the pre-strand compositions, a liquid bridge is formed between the pre-strand compositions on the nucleation element and the pre-strand composition remaining in a reservoir, with the polymer strand forming between the nucleation element and the reservoir as the nucleation element is further pulled away from the reservoir. The nucleation element provides for non-random nucleation of the polymers. With non-random nucleation, the one or more nucleation sites may be pre-determined for better control over strand growth and other process steps. The nucleation element has a size and shape such that the polymers form a strand as the nucleation element is withdrawn from the pre-strand compositions. Aspect ratio (height to maximum width) of the nucleation element is preferably in a range of from 1:100 to 1000:1. In some embodiments, the aspect ratio is preferably in a range of 1:1 to 1000:1. The nucleation element preferably has a cap of sufficiently small width to permit the initial adherence of a thin polymer strand thereon when the cap is inserted into the pre-strand compositions. The width of the nucleation element where the polymer strand adheres is preferably 0.5-4 mm, more preferably 2-4 mm. In some embodiments, the width of the nucleation element may be 1 mm or less, or 0.75 mm or less, for example 0.5 mm. The cap preferably has geometry that is flat, conical, pyramidal or ellipsoidal.

The nucleation element has a surface, and the nucleation element is preferably inserted into the pre-strand compositions so that the surface of the nucleation element is wetted by each pre-strand composition over a surface area of at least 11 mm², preferably at least 50 mm². Preferably, the wetted surface area is up to 400 mm², more preferably up to 200 mm², even more preferably up to 110 mm². Preferably, the wetted surface area is in a range of 11-400 mm², more preferably 11-200 mm², even more preferably 11-110 mm², yet more preferably 50-110 mm², even yet more preferably 60-90 mm².

For pulling one polymer strand, a single nucleation element may be used. However, a plurality of strands may be pulled simultaneously from the same pre-strand composition by using a plurality of discrete nucleation elements. The plurality of nucleation elements may be provided in an array, either a regular array or an irregular array, with regular or random spacing. Where a plurality of nucleation elements is used, the plurality of nucleation elements preferably has a minimum center-to-center spacing between nucleation elements of at least 1.5 times, preferably at least 2 times, more preferably at least 2.5 times, a diameter of a thickest neighboring nucleation element. In some embodiments, the spacing is at least 0.2 mm, preferably at least 0.5 mm, more preferably at least 1 mm. The lower limits arise primarily due to the resolution of 3D printers and tolerances that can be achieved by machining. The desired strand thickness will also inform the minimum spacing as well as the width of the nucleation elements. Greater pin spacing and/or wider nucleation elements may be required for thicker strands. The nucleation elements may be manufactured by any suitable method, for example 3D printing or machining. The nucleation elements may have any suitable geometry, for example polygonal or elliptical in cross section. Some examples of nucleation elements include a pin, a needle, a rod and a protrusion (e.g., a pillar, a ridge, a nodule, a granule or the like) on a surface. In some embodiments, a plurality of one or more types of such nucleation elements are mounted on a base and used to pull multiple strands at the same time. Thus, pin brushes and the like may be used to pull a plurality of strands simultaneously.

The nucleation element may be embodied in an apparatus that contains features for mounting or tethering the nucleation element, containing the pre-strand compositions and translating the nucleation element into and out of the pre-strand compositions. During strand formation, the nucleation element can be oriented in any direction, e.g., horizontally, or vertically. In some embodiments, the pre-strand compositions are contained in a reservoir with the first and second pre-strand compositions disposed vertically one on top of the other, or horizontally in a side-by-side arrangement. Other mounting and containing arrangements can be envisioned by one skilled in the art. Features for translating the nucleation element may include a motorized or hand driven stage. Automated apparatuses are preferred.

After strand nucleation on the nucleation element, the strand may be transferred from the nucleation element to a strand winding mechanism (e.g., a continuous spinning apparatus, such as a Godet) that is capable of continuously pulling and collecting the strand. In this manner, a strand of indeterminate length can be produced.

### EXAMPLES

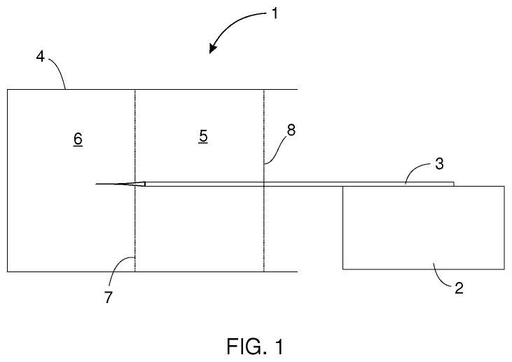

With reference to FIG. 1, by way of example, free surface spinning of core-sheath polymer strands is described using a simple horizontal contact drawing system 1 comprising a motorized linear stage 2, a microneedle 3 mounted on the stage 2, and a liquid reservoir 4 containing an aqueous two-phase system (ATPS) comprising two immiscible aqueous polymer solutions 5, 6. The two immiscible polymer solutions (phases) exemplified here are an aqueous solution of dextran 5 (dextran phase) and an aqueous solution of polyethylene oxide (PEO) 6 (PEO phase). The aqueous polymer solutions 5, 6 are disposed side-by-side in the reservoir 4 with a phase separation interface 7 between the aqueous polymer solutions 5, 6 where the aqueous polymer solutions 5, 6 are in contact with each other. Because the interfacial tension between PEO and dextran is lower than the interfacial tension in oil/water systems, the present approach removes the need for emulsifiers as well as high-pressure mechanical mixing or ultrasonic homogenization, both of which might affect the structure and function of any compounds that may be encapsulated in the polymer strand that is produced. The stage 1 is configured to move linearly, or configured to move the microneedle 3 linearly to be able to insert the microneedle 3 into the reservoir 4 and remove the microneedle 3 from the reservoir 4 along a constant linear path at a constant speed through a fixed distance. The system 1 is arranged so that when the microneedle 3 is inserted into the reservoir 4, the microneedle 3 first encounters the dextran phase 5 before encountering the PEO phase 6. Likewise, when the microneedle 3 is retracted from the reservoir 4, the microneedle 3 passes out of the dextran phase 5 into the outside environment (air) through a dextran/air interface 8. Further details of contact drawing are provided below.

### Example 1—Production of Dextran-PEO Core-Sheath Strands

### Materials and Methods:

### Polymer Solutions

PEO (1 MDa; Sigma-Aldrich) and dextran (500 kDa; Dextran Products Ltd.) were dissolved in deionized water to obtain solutions of 10-15% wt PEO and 50-60% wt dextran. The polymer solutions were mixed by vortexing for 10 minutes, followed by bath ultrasonication until a homogeneous solution formed. Once the polymers had dissolved, the solutions were stored at room temperature or in a refrigerator at about 4° C.

Fluorescein isothiocyanate (FITC)-labelled dextran (500 kDa; Sigma-Aldrich) and either pyrene-polyethylene glycol (PEG)-rhodamine or mPEG-FITC (both 10 kDa; Creative PEGWorks) were dissolved in the dextran and PEO solutions, respectively, at 0.1% wt for fluorescence imaging of the polymer solutions and core-sheath fibers.

### Contact Drawing

A 2×5×5 mm rectangular reservoir with open faces at the top and front was fabricated using a B9 Creator™ microstereolithography 3D printer using B9R-2 Black Resin (B9 Creations) (see Chowdhry G, et al. Polymer entanglement drives formation of fibers from stable liquid bridges of highly viscous dextran solutions. Soft Matter. 17 (7), 1873-1880 (2021), the entire contents of which is herein incorporated by reference). The reservoir was used to hold the viscous polymer solutions for contact drawing using a steel microneedle with a tip diameter of 0.1 mm and a shank diameter of 0.5 mm (Ted Pella; product no. 13601C). For fiber formation/failure analysis of individual PEO and dextran solutions, approximately 50 μL of fluid was added to the reservoir using a syringe. For all other experiments, approximately equal volumes of PEO and dextran solutions were added to the reservoir such that one of the polymer solutions was at the back of the reservoir and the other was at the front of the reservoir, with the interface between the polymer solutions perpendicular to the bottom of the reservoir and the microneedle path.

The steel microneedle was mounted on a linear translation stage (Thorlabs; DDSM100/M). The stage was programmed to move the microneedle tip to enter the reservoir at a speed of 30 mm/s to a depth of approximately 5 mm. At this depth, the microneedle paused for 0.5 s and then returned to its original position at a controlled speed (vₚᵤₗₗ) for a path length of 100 mm. The acceleration was set to 5000 mm/s² and the maximum speed was approximately 400 mm/s. For each Vₚᵤₗₗ, a failure rate was calculated according to:

$$failure rate ( \% ) = \frac{number of failed trials}{number of total trials} \times 100. \qquad ( 1 )$$

Starting with a failure rate of 0%, the Vₚᵤₗₗ was decreased until a failure rate of 100% was observed.

An imaging system comprising a Mightex™ 5 Megapixels CMOS camera, a long-working distance lens assembly and a 150-watt Halogen light source (Fiber-Lite™ Mi-150 Illuminator series) was used to record movies of the strand formation process in the vicinity of the reservoir at a rate of 60 frames per second. These images were later processed using the threshold utility in MATLAB™ to understand the thinning profile of the liquid bridge. An in-house MATLAB™ script was used to compute the diameter of the liquid bridge a few millimeters away from the base of the spin cone by tracking the positions of the edges of the dark spin cone relative to the light background.

To observe the fluid dynamics of the dextran and PEO solutions inside the reservoir, a separate glass reservoir of similar dimensions to the 3D printer reservoir was fabricated by affixing two 25×25 mm glass coverslips together using a bead of hot glue of approximately 2 mm in height. This created a single use transparent reservoir through which the movement of the microneedle, dextran phase and PEO phase could be recorded using either the Mightex™ camera setup described above or a Yinama™ portable digital microscope with an integrated color camera.

### Fluorescence Microscopy

A Nikon Eclipse™ Ti optical microscope equipped with 10X and 20× magnification long working distance objective lenses was used for routine inspection of FITC-dextran and pyrene-PEG-rhodamine containing fibers, as well as to record fluorescence images of the PEO and dextran phases in the transparent reservoir after needle withdrawal. For detailed inspection of strand morphology and confirmation of core-sheath strand production, the strands were observed using a Leica™ SP8 near super-resolution laser scanning confocal microscope equipped with a 20x air-objective (NA 0.75 and WD 0.21 mm). For presentation purposes, fluorescence images were processed in Image J to adjust brightness and contrast and color balance. Quantification of core diameter was performed in MATLAB™. Attenuated Total Reflectance Fourier Transform Infrared Spectroscopy (ATR FTIR)

A Thermo Scientific Nicolet™ iZ10 MX integrated FTIR microscope was used to collect infrared spectra of the fibers. This instrument enables recording of IR spectra and analyzes microscopic strands with a minimal aperture of 25 μm×25 μm. The mapping function was performed in ATR mode using a Slide-On ATR objective with a conical germanium crystal and MCT detector cooled with liquid nitrogen. The contact pressure between the crystal and the strands was varied to collect the spectra of strands formed from only dextran and PEO (2% pressure) and from core-sheath fibers (30% pressure). Spectra consisted of 16 scans measured between 400 and 4000 cm⁻¹ with a spectral resolution of 4 cm⁻¹. Prior to data collection, atmospheric suppression was carried out to correct for CO2 and humidity absorbance. Data collection and post-processing of the spectra were performed using OMNIC PICTA™ software.

### Results and Discussion:

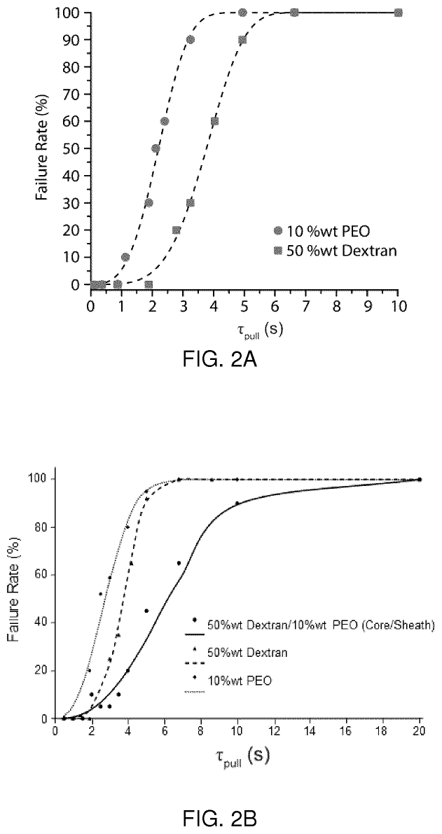

Free surface spinning of contact drawn strands from a single polymer solution is driven by polymer entanglement. The reptation model for polymer entanglement predicts a characteristic time scale with respect to motion of the polymer chains, above which polymer chains can move freely about one another, and below which the polymer chains form entanglements at contact points with nearby polymer chains. At slower pull speeds corresponding to longer time scales, there is thus a lower probability that a strand will form from the entangled polymer solution. The ability to form strands from various polymer formulations (as shown in FIG. 2A and FIG. 2B) can be understood by analyzing failure rate according to the Weibull cumulative distribution function:

$$failure rate = 1 - exp [ - {( \frac{{τ}_{pull}}{a} )}^{k} ] , \qquad ( 2 )$$

where k is the shape parameter representing the width of the distribution and a is the scale parameter corresponds to the time at which the failure rate is 63%.

### Failure Analysis

Strand formation begins with the formation of a liquid bridge between the surface of the viscous polymer solution and the tip of the microneedle. As the contacting substrate moves away from the surface of the fluid, the fluid in the liquid bridge is drawn into a strand through extensional flow, resulting in a strand that dries rapidly in air as it extends. The formation of the liquid bridge depends on the viscosity of the fluid and its tendency to form entanglements at the time scale over which the microneedle moves through the fluid. In the failure analysis of polymer solutions.

As seen in FIG. 2A, strands formed more efficiently for a 50% wt solution of dextran than for a 10% wt solution of PEO, as indicated by the shift in the Weibull distribution towards longer τₚᵤₗₗ values. As seen in FIG. 2B, for the core-sheath strands, the results were relatively similar to PEO and dextran alone, with 0% failure rates obtained at τₚᵤₗₗ durations up to 1.5 seconds, however, 100% failure was not obtained until a much higher τₚᵤₗₗ value of 20 seconds. A comparison of the failure distribution curves for dextran, PEO, and dextran/PEO core-sheath are seen in FIG. 2B. The strands formed least efficiently with 10% wt PEO, slightly better with 50% w % dextran, and the best with the core-sheath strands, as illustrated by a rightward shift in the curves, showing decreased failure rates at larger τₚᵤₗₗ values (FIG. 2B). For example, between τₚᵤₗₗ values of 2 seconds and 4 seconds, the failure rates of the core-sheath strands were between 5% and 20%, whereas the failure rates were between 65% and 80% for the individual polymers at a τₚᵤₗₗ value of 4 seconds.

The failure analysis helps evaluate the formation of liquid bridges and consequently strand formation between the polymer solution and the microneedle. When drawn, the liquid bridge forms a strand through extensional flow which dries rapidly as the strand extends. Overall, the core-sheath strands were able to withstand slower pull speeds while maintaining a lower failure rate. Thus, the core-sheath strands are better able to produce successful strands at lower pull speeds. Since core-sheath strands can be pulled at slower pull speeds with a lower failure rate compared to the single polymer strands, core-sheath strands are better suited for scaling-up and can be utilized in more applications. Further, in the middle-range of pull speeds, i.e., τₚᵤₗₗ values in a range of 2 seconds to 4 seconds, the core-sheath strands appeared noticeably stiffer, stronger, and thicker.

Observing real-time video of the contact drawing process shows the behavior of the viscous stock solutions of dextran and PEO. Consistent with other reports of the viscoelastic behavior of dextrans of various molecular weights and concentrations, the solution of 50% wt dextran behaved as a Newtonian fluid, although some studies have observed modest shear-thinning behavior for high molecular weight dextrans of 30% wt or above attributed to presence of branches within the dextran chains. In contrast, PEO behaved as a non-Newtonian shear-thinning fluid at all concentrations above those sufficient for entanglement to occur, which was consistent with previous reports of the rheology of aqueous solutions of PEO. Contrary to dextran solutions, for which the time scale for strand formation was purely controlled by the entanglements dynamics, the results for PEO imply that the time scale for strand formation from the PEO solution is controlled by the entanglements dynamics and by a shear strain rate-dependent thinning process.

Fluid Dynamics of Liquid Bridge Formation from Dextran/PEO Solutions

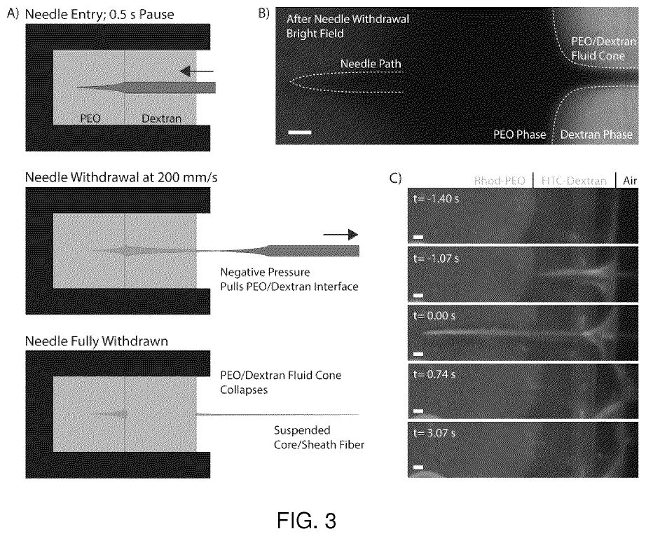

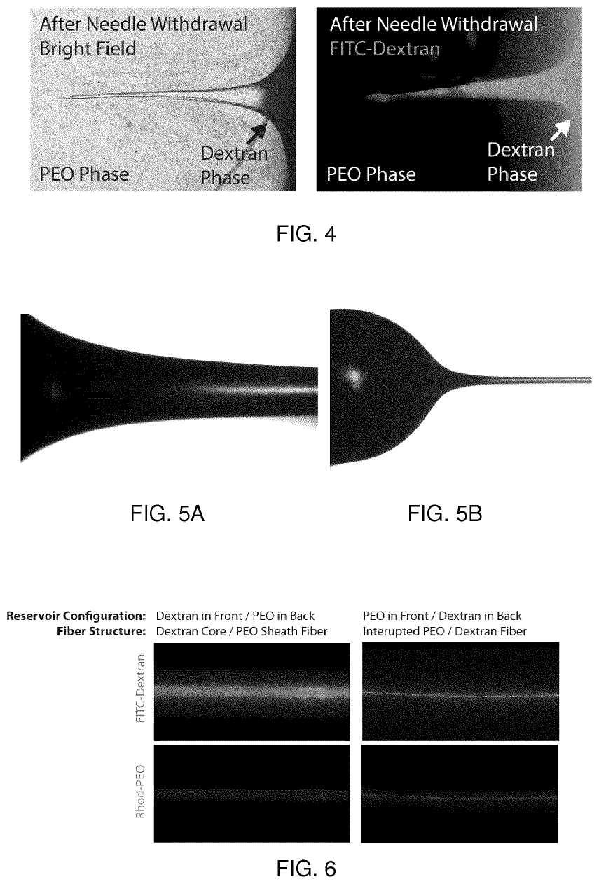

With an understanding of the critical time scales for formation of polymer strands from individual solutions of dextran and PEO, their ability to form strands from an ATPS formed from these polymer solutions was explored. One of the polymer solutions was placed at the back of the reservoir and the other at the front of the reservoir. FIG. 3A depicts the proposed mechanism for strand formation from an ATPS in which the dextran solution is located at the front of the reservoir and the PEO solution is located at the back of the reservoir. The microneedle first moves through the dextran solution, and as the microneedle enters the PEO phase, the microneedle deflects the phase separation interface rather than penetrating through the phase separation interface. As the microneedle is withdrawn, a negative pressure is created that draws a thin-walled cone of PEO through the dextran phase (FIG. 3A middle panel, FIG. 3B and FIG. 5A). The path of the microneedle through the PEO phase is evident by bright field imaging and fluorescence imaging of FITC-dextran incorporated into the dextran phase at least several minutes after the microneedle has been removed because the PEO phase does not flow in the absence of shear (see FIG. 4). The cone of PEO in the dextran phase, however, is a transient structure that disappears once the liquid bridge forms at the dextran-air interface, as evidenced by the absence of pyrene-PEG-rhodamine signal in the dextran phase less than a minute after microneedle withdrawal. The cone of dextran in the air as the core-sheath strand is being formed is illustrated in FIG. 5B. At the end of a successful strand formation event, a strand that contains signal from both FITC-dextran and pyrene-PEG-rhodamine can be observed by epifluorescence imaging (see FIG. 6, left panel). The time course over which these events occur, showing the movement of the microneedle with respect to the air-dextran-PEO interface, is shown in FIG. 3C.

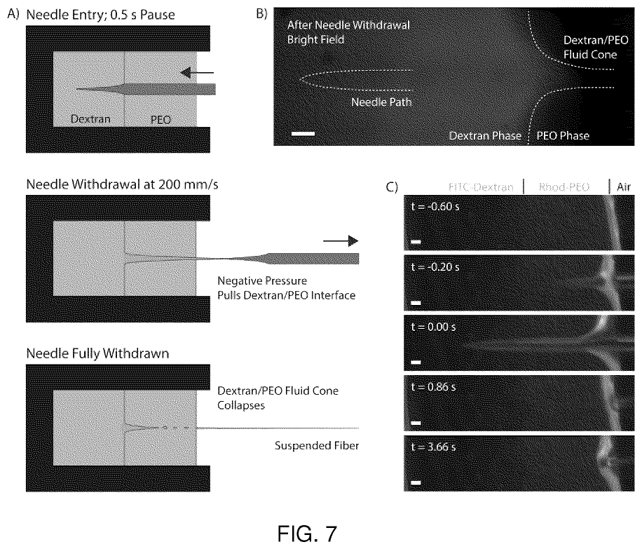

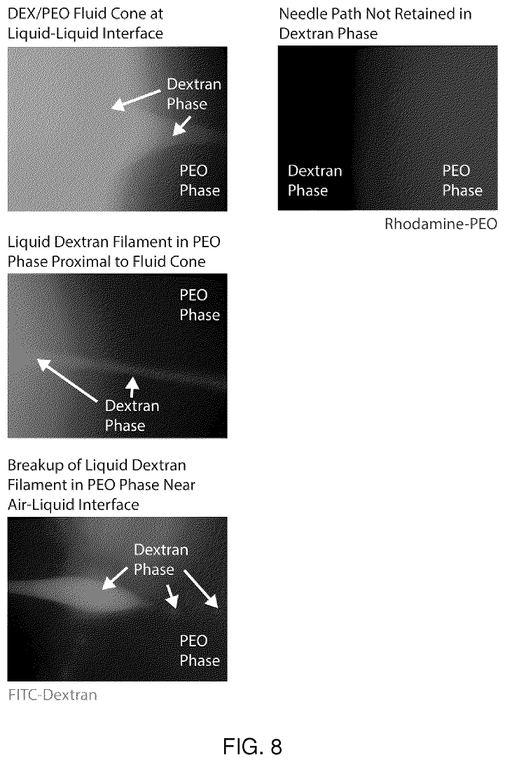

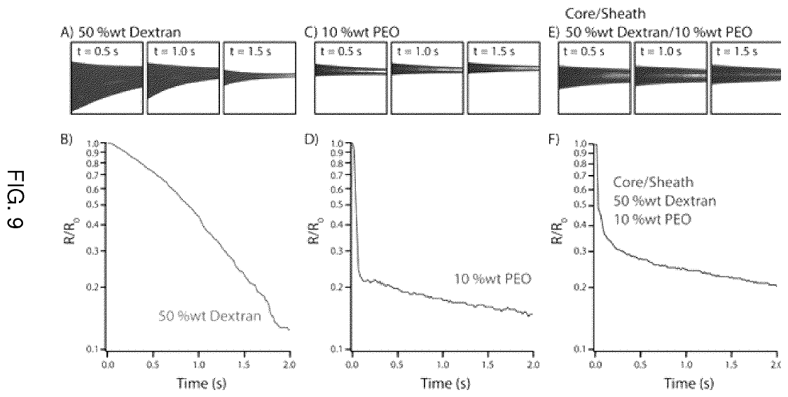

When the dextran solution is placed at the back of the reservoir and the PEO solution is placed at the front of the reservoir, the negative pressure created by withdrawal of the microneedle this time produces a thin-walled cone of dextran through the PEO phase (see FIG. 7 and FIG. 8). Several minutes after withdrawal of the microneedle through the PEO phase, the microneedle path through the dextran was evident, and there was a partially collapsed cone of dextran present in the PEO phase, with signs of instability and breakup of the thin-walled dextran column present in the PEO phase close to the air-PEO interface (FIG. 7). The strands formed under this configuration were appreciably thinner than the strands formed from the configuration where dextran was at the front of the reservoir. Furthermore, the presence of signal from FITC-dextran and pyrene-PEG-rhodamine was discontinuous along the length of the strands in epifluorescence images (see FIG. 6, right panel). These data demonstrate a complex flow pattern that occurs within the reservoir that is carried into the liquid bridge and resulting strand and suggest the presence of a core-sheath structure only when the PEO solution is drawn as a thin liquid sheath through the dextran phase.

Differences in the morphology and dynamics of the spin cones formed from dextran, PEO and the ATPS formed from dextran and PEO were also evident (see FIG. 9). For a solution of 50% wt dextran, the spin cone was either symmetrical or oblique depending on its proximity to the side of the reservoir (FIG. 9A) and the radius decayed linearly over time (FIG. 9B), as expected for thinning of a Newtonian liquid bridge in the viscocapillary regime. For a solution of 10% wt PEO, the volume of the cone was smaller than for the cone formed from 50% wt dextran (FIG. 9C) and after an initial phase of rapid exponential-like decay, the radius decayed exponentially at a slower rate (FIG. 9D), as expected for thinning of a polymer liquid bridge in the elastocapillary regime. The spin cones produced from the ATPS formed from 50% wt dextran and 10% wt PEO were smaller in volume than spin cones formed from dextran but were larger in volume than spin cones formed from PEO (FIG. 9E). The radiuses of spin cones produced from the ATPS decayed exponentially at a similar rate to the PEO spin cones, following an initial phase of rapid exponential-like decay (FIG. 9F). This radius decay behavior is likely driven by relative differences in the viscoelastic properties of the two polymers. Fluid from the PEO phase will only enter the cone under shear and there is a secondary flow within the cone back to the reservoir, as confirmed by visual observation of the process. For dextran, we previously observed that strand diameter increases with dextran concentration, and this is likely due to the larger volume of fluid present in the spin cones for various dextran formulations relative to those formed from PEO.

Core Diameter Scales with Dextran Concentration

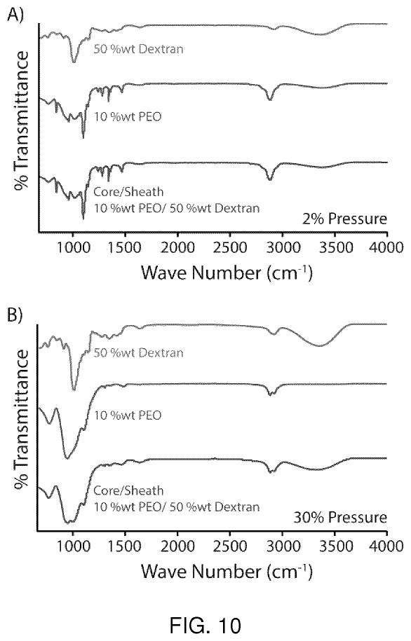

The presence of a core-sheath structure in the strands formed from an ATPS was verified by ATR FTIR (see FIG. 10). At low applied pressure between the germanium crystal and the fibers (2% pressure), the FTIR spectra for the PEO and the core-sheath strands appear identical and the prominent and narrow dextran peak at around 1100 cm⁻¹ is not detected at the surface of the core-sheath fiber (FIG. 10A). Since light penetrates 0.66 micrometers under these conditions, it may be that the PEO sheath has a thickness of greater than 0.66 micrometers. Increasing the applied pressure to 30% for the two pure fibers, does not change the FTIR spectrum of the dextran fiber but modifies the PEO peaks in the 800 to 1200 cm⁻¹ region (FIG. 10B). Increasing the pressure to 30% on the core-sheath strand creates a mixed spectrum where the dextran peak at around 1100 cm⁻¹ is present along with the PEO peaks in the 800 to 1200 cm⁻¹ region (FIG. 9B).

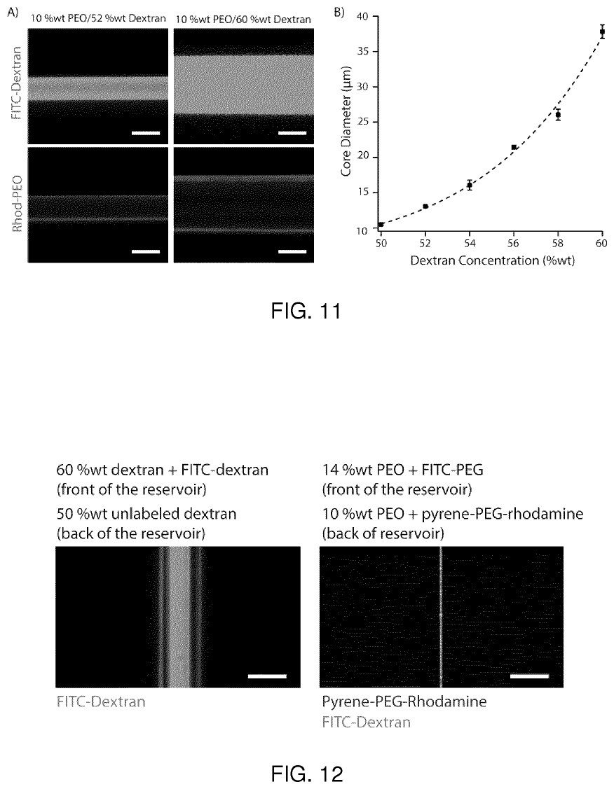

The presence of core-sheath structures in the strands formed from the ATPS was conclusively confirmed by confocal microscopy, which also enabled analysis of strands that varied with respect to core diameter as a function of dextran concentration (see FIG. 11). Tuning of core diameter is possible by varying the weight percentage of dextran added to the reservoir from which the strands are drawn. The core diameter increased as dextran concentration increased from 50% wt to 60% wt. However, the thickness of the PEO sheath did not increase with increasing dextran concentration, implying that the dextran formulation is the major determinant of core-sheath strand diameter and that the PEO sheath thins along the length of the strand as the strand is extended by the contact drawing apparatus. Finally, the ability to form core-sheath structures was explored with a solution of 60% wt dextran containing FITC-labeled dextran placed at the front of the reservoir and a solution of 50% wt unlabeled dextran placed at the back of the reservoir, as well as with a solution of 14% wt PEO containing FITC-labeled PEO placed at the front of the reservoir and a solution of 10% wt PEO containing pyrene-PEG-rhodamine placed at the back of the reservoir (see FIG. 12). For the combination of 60% wt dextran at the front of the reservoir and 50% wt dextran at the back of the reservoir, the resulting strands had a fine outer sheath structure formed from the 60% wt dextran solution, a thicker inner sheath structure formed from the 50% wt dextran solution, and a core formed from the 60% wt solution. For the combination of 14% wt PEO at the front of the reservoir and 10% wt PEO at the back of the reservoir, a thin strand formed with no apparent core-sheath structure. These data suggest that an ATPS is desirable for the formation of a core-sheath structure by free surface spinning.

Example 1 demonstrates a relatively simple, nozzle-free approach for generating core-sheath strands from an ATPS formed from dextran and PEO. Free surface spinning of core-sheath strands following formation of a contact-drawn liquid bridge can be scaled by moving from a single pin apparatus to a multi-pin array.

### Example 2—Cross-linking of PEO and Dextran Strands

### Materials and Methods:

### Polymer Solutions

For cross-linking PEO, polyethylene glycol diacrylate (PEGDA) (4000 DA, Polysciences) cross-linker together with Irgacure™ 2959 (Sigma-Aldrich, 1-[4-(2-hydoxyethoxy)-phenyl]-2-hydroxy-2-methyl-1-propane-1-one) photoinitiator were used. Irgacure™ 2959 has an absorption peak at 365 nm. Aqueous solutions of 10% wt PEO with 25% wt PEGDA, 10% wt PEGDA, 5% wt PEGDA and 0% wt PEGDA were prepared similarly to the solutions prepared in Example 1. The prepared solutions were either treated with 2% wt Irgacure™ 2959 or used without photoinitiator before contact drawing was to be performed.

For cross-linking dextran, photo-dextran, a methacrylated dextran with a MW between 35 and 50 kDa (Advanced Biomatrix), was used. Solutions of 40% wt dextran and 10% wt photo-dextran, 50% wt dextran and 5% wt photo-dextran, 50% wt dextran and 2.5% wt photo-dextran, and 50% wt dextran and 0% wt photo-dextran were prepared similarly to the solutions prepared in Example 1. The prepared solutions were either treated with 2% wt Irgacure™ 2959 before contact drawing was to be performed or used without addition of the photoinitiator.

Before pulling polymer strands from the prepared PEO and PEGDA polymer solutions, or the prepared dextran and photodextran polymer solutions, Irgacure™ 2959 was added. Before adding Irgacure™ 2959 to the polymer solutions, the Irgacure™ 2959 was dissolved in dimethyl sulfoxide (DMSO) at a concentration of 100 mg/mL. Vortexing was used to homogenize the photoinitiator, which was added to each polymer solution in an appropriate amount to provide the desired amount of photoinitiator. The polymer solutions with the newly added photoinitiator were stored wrapped in tin foil.

Contact drawing was performed in a manner similar to Example 1.

### UVC Cross-Linking of Polymer Strands

To cross-link polymer strands, a UVP Cross-linker CL-3000 machine, purchased from analytikjena, was used. Polymer strands were treated with UVC at 400 mJ/cm² and 0 mJ/cm² (no UVC). Glass microscope slides with strands pulled thereover were placed in the machine and irradiated with the desired UVC amount. The polymer strands were stored in the dark after UVC treatment.

### Hydration of Cross-Linked Polymer Strands

Hydration with 2 mL of 1×PBS was used to determine the level of cross-linking that occurred within each of the strand samples. A scalpel was used to gently cut the strands surrounding the glass coverslip on the glass microscope slide. A cyanoacrylate glue was used to place four small dollops of glue on the bottom of the coverslip in each corner before being place in one well of a 6-well plate. Four small dollops of glue were also placed on top of the strands in each of the four corners of the coverslip slide to ensure the strands remained in position. Each of the wells of the 6-well plate was occupied in a similar manner with other samples. The plates were then wrapped in tin foil to keep the fibers in the dark. 2 ml of 1×PBS was added to each well plate to hydrate the strands.

### Microscope Imaging

To qualitatively monitor the level of cross-linking that occurred with the polymer strands, microscope images were taken of the strands as drawn (before hydration), 1 hour after hydration.

### Results and Discussion:

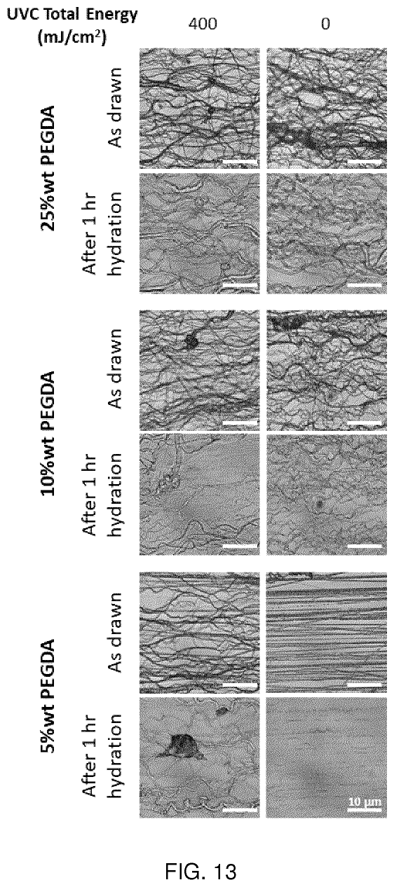

FIG. 13 shows microscope images before hydration (as contact drawn) and 1 hour after hydration with PBS for PEO polymer strands that were UVC cross-linked in the presence of 25% wt, 10% wt, and 5% wt PEGDA, with 2% wt Irgacure™ 2959 as a photoinitiator. Samples were irradiated with UVC radiation at an intensity of 400 mJ/cm² or 0 mJ/cm². The cross-linked strands appear clearer and more transparent after hydration, compared to before hydration. At a low PEGDA concentration of 5% wt the fibers become more transparent after hydration as compared to fibers formed in the presence of 25% wt and 10% wt PEGDA, suggesting that PEO fibers that are less crosslinked are also less stable in aqueous media.

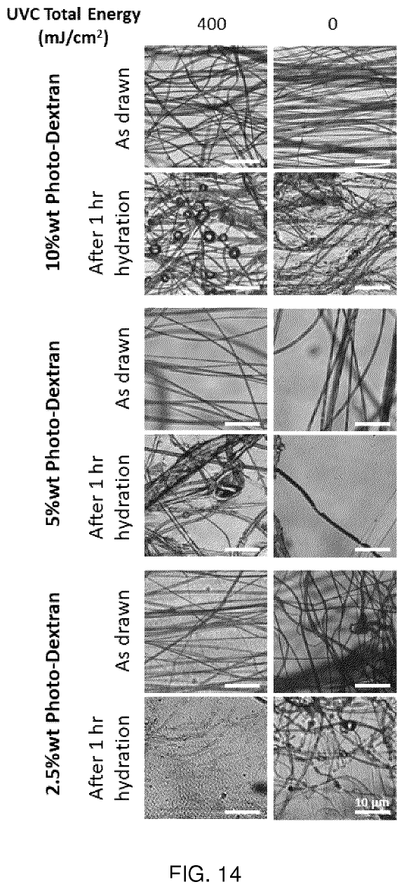

FIG. 14 shows microscope images before hydration (as contact drawn) and 1 hour after hydration with PBS for dextran strands that were UVC cross-linked in the presence of 10% wt, 5% wt and 2.5% wt photo-dextran and 2% wt Irgacure™ 2959. The same UVC irradiation conditions as described above were used. Similar to crosslinked PEO strands, the cross-linked dextran strands appear clearer and more transparent after hydration, compared to before hydration. At low photo-dextran concentrations (5% wt or less) the fibers become more transparent after hydration as compared to fibers formed in the presence of 10% wt photo-dextran, and in some cases the fibers dissolved completely, suggesting that dextran fibers that are less crosslinked are also less stable in aqueous media.

Further, UVC exposure level, photoinitiator concentration and cross-linking agent concentration did not significantly affect the shape and uniformity of the cross-linked PEO strands before and after hydration, which is unexpected. It was believed that a cross-linking agent was required for cross-linking to occur and to resolve the solubility issue since PEO and dextran are hydrophilic and should dissolve away when hydrated. Further testing of PEO strands exposed to UVC light in the absence of both PEGDA, photo-dextran and Irgacure™ 2959 showed that strands completely lost their shape and dissolved after being hydrated for 1 hour (FIG. 16), supporting the notion that Irgacure™ 2959 and cross-linking agents (PEGDA and photo-dextran) are required for fabricating fibers that are stable in aqueous media.

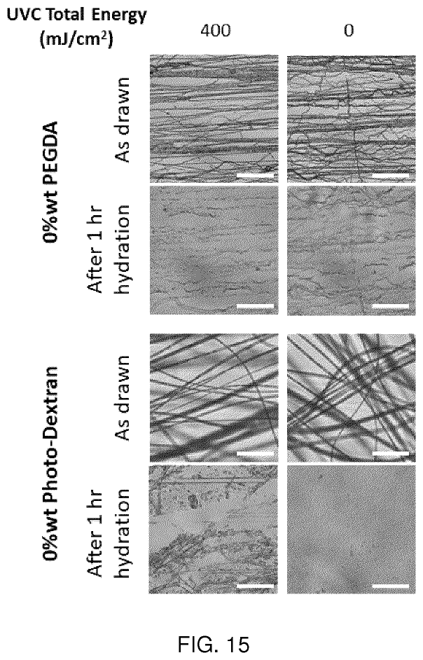

Atmospheric relative humidity was noted before contact drawing. The PEO strands at all concentrations of PEGDA and with 2% wt Irgacure™ 2959, and the PEO strands cross-linked without the presence of Irgacure™ 2959, were pulled at a relative humidity between 50% and 60% (FIG. 13 and FIG. 15). The dextran strands cross-linked in the presence of: 2.5% wt photo-dextran were pulled at a relative humidity of 40%; in the presence of 5% wt photo-dextran were pulled at a relative humidity of below 20%; and, in the presence of 10% wt photo-dextran were pulled at a relative humidity of 50% (FIG. 14). The dextran strands exposed to UVC without the presence of photo-dextran and photoinitiator were pulled at a relative humidity of 50% (FIG. 15).

### Example 3—Production of Cross-linked Dextran-PEO Core-Sheath Strands

To produce core-sheath dextran-PEO strands in which the core and/or the sheath have been cross-linked, the contact drawing process as described in Example 1 is used except that a cross-linking agent for PEO (e.g., 2,5-bis(tert-butylperoxy)-2,5-dimethylhexane, PEGDA, etc.) is added to the PEO phase in the reservoir and/or a cross-linking agent for dextran (e.g., lysine, photo-dextran, etc.) is added to the dextran phase in the reservoir. The cross-linking is initiated, for example with UV irradiation with or without a photoinitiator) and the core-sheath strand is drawn resulting in a core-sheath polymer strand in which one or both of the core and the sheath are cross-linked.

### Example 4—Production of Dextran-PEO Core-Sheath Strands with Functional Additives

To produce core-sheath dextran-PEO strands in which the core and the sheath are loaded with functional additives, the process as described in Example 3 except that a functional additive (an antibody or a nucleotide or a polynucleotide) is also added to the PEO phase in the reservoir and a functional additive (an antibody or a nucleotide or a polynucleotide) is also added to the dextran phase in the reservoir.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A process for producing a core-sheath polymer strand, the process comprising:
inserting a nucleation element through a first pre-strand composition at least partially into a second pre-strand composition, the first pre-strand composition comprising a first polymer and the second pre-strand composition comprising a second polymer;
withdrawing a nucleation element from the second pre-strand composition through the first pre-strand composition; and then,
continuing to pull the nucleation element out of the first pre-strand composition so that a polymer strand comprising a core of the first polymer encapsulated by a sheath of the second polymer is pulled by the nucleation element out from the pre-strand compositions.

2. The process of claim 1, wherein:
the first pre-strand composition is immiscible in the second pre-strand composition;
the first pre-strand composition is in contact with the second pre-strand composition at a phase separation interface; and,
the second pre-strand composition has a higher zero-shear viscosity than the first pre-strand composition.

3. The process of claim 1, wherein the nucleation element is withdrawn at a rate such that a pull time (τₚᵤₗₗ) of the nucleation element is:
less than a first reptation time (τᵣₑₚ1) required to relax polymer entanglements in the first pre-strand composition; and,
less than a second reptation time (τᵣₑₚ2) required to relax polymer entanglements in the second pre-strand composition,
thereby inducing viscoelastic responses in the pre-strand compositions as the polymer strand is pulled by the nucleation element.

4. The process of claim 1, wherein the first polymer is alginic acid, amylopectin, bovine serum albumin, carageenan, carboxymethyl cellulose, carboxymethyl dextran, casein, chitosan, chondroitin sulfate, collagen, dextran, dextran sulfate, diethylaminoethyl dextran, fetal bovine serum, gelatin, guar gum, gum arabic, gum ghatti, hyaluronic acid, hydroxyethyl cellulose, hydroxyethyl starch, hydroxypropyl cellulose, hydroxypropyl methylcellulose, lignin, methyl cellulose, mucin, pectin, peptone, poloxamer 407, poly(2-acrylamido-2-methyl-1-propanesulfonic acid), poly(2-ethyl-2-oxazoline), polyethylene oxide, poly(4-styrenesulfonic acid), poly(4-styrenesulfonic acid-co-maleic acid), poly [bis(2-chloroethyl) ether-alt-1,3-bis [3-(dimethylamino) propyl] urea] quaternized, poly-(α,β)-DL-aspartic acid, poly-D-lysine, poly(acrylamide), poly(acrylic acid), poly(allylamine), poly(diallyldimethyl ammonium chloride), poly(ethylene glycol), poly(ethylene glycol) diacrylate, poly(ethylenimine), poly(methacrylic acid), poly(methyl vinyl ether-alt-maleic acid), poly(N-isopropylacrylamide), poly(propylene glycol), poly(sucrose), poly(vinyl alcohol), poly(vinylpyrrolidone), poly(vinylsulfonic acid), polyoxyethylene (9) nonylphenylether, polyoxyethylene (20) sorbitan monolaurate, polyoxyethylene (23) lauryl ether, a pullulan, a silk, tragacanth or xanthan gum.

5. The process of claim 1, wherein the second polymer is alginic acid, amylopectin, bovine serum albumin, carageenan, carboxymethyl cellulose, carboxymethyl dextran, casein, chitosan, chondroitin sulfate, collagen, dextran, dextran sulfate, diethylaminoethyl dextran, fetal bovine serum, gelatin, guar gum, gum arabic, gum ghatti, hyaluronic acid, hydroxyethyl cellulose, hydroxyethyl starch, hydroxypropyl cellulose, hydroxypropyl methylcellulose, lignin, methyl cellulose, mucin, pectin, peptone, poloxamer 407, poly(2-acrylamido-2-methyl-1-propanesulfonic acid), poly(2-ethyl-2-oxazoline), polyethylene oxide, poly(4-styrenesulfonic acid), poly(4-styrenesulfonic acid-co-maleic acid), poly [bis(2-chloroethyl) ether-alt-1,3-bis [3-(dimethylamino) propyl] urea] quaternized, poly-(α,β)-DL-aspartic acid, poly-D-lysine, poly(acrylamide), poly(acrylic acid), poly(allylamine), poly(diallyldimethyl ammonium chloride), poly(ethylene glycol), poly(ethylene glycol) diacrylate, poly(ethylenimine), poly(methacrylic acid), poly(methyl vinyl ether-alt-maleic acid), poly(N-isopropylacrylamide), poly(propylene glycol), poly(sucrose), poly(vinyl alcohol), poly(vinylpyrrolidone), poly(vinylsulfonic acid), polyoxyethylene (9) nonylphenylether, polyoxyethylene (20) sorbitan monolaurate, polyoxyethylene (23) lauryl ether, a pullulan, a silk, tragacanth or xanthan gum.

6. The process of claim 1, wherein the first and second polymers are different polymers.

7. The process of claim 6, wherein the first and second polymers are immiscible in each other.

8. The process of claim 1, wherein the first pre-strand composition comprises the first polymer dispersed in a first liquid medium and the second pre-strand composition comprises the second polymer dispersed in a second liquid medium.

9. The process of claim 8, wherein the first liquid medium is a first solvent that dissolves the first polymer, the second liquid medium is a second solvent that dissolves the second polymer, or the first liquid medium is a first solvent that dissolves the first polymer and the second liquid medium is a second solvent that dissolves the second polymer.

10. The process of claim 8, wherein the first and second liquid media are both aqueous media.

11. The process of claim 1, further comprising cross-linking the first polymer, the second polymer or both the first and second polymers before the strand is formed, as the strand is formed or after the strand is formed.

12. The process of claim 11, wherein the first polymer is cross-linked to a different extent than the second polymer.

13. The process of claim 1, wherein the first pre-strand composition comprises one or more first functional additives, the second pre-strand composition comprises one or more second functional additives, or the first pre-strand composition comprises one or more first functional additives and the second pre-strand composition comprises one or more second functional additives.

14. The process of claim 13, wherein the functional additives comprise one or more pharmaceutically active agents, one or more precursors of pharmaceutically active agents or combinations thereof.

15. A core-sheath polymer strand comprising a core comprising a first polymer encapsulated by a sheath comprising a second polymer, wherein:
the first polymer is cross-linked; and,
the second polymer is cross-linked.

16. The core-sheath polymer strand of claim 15, wherein the first polymer has a functional additive entrained therewith or the second polymer has a functional additive entrained therewith.

17. The core sheath polymer strand of claim 15, wherein:
the first polymer has a first functional additive entrained therewith;
the second polymer has a second functional additive entrained therewith; and,
the first functional additive is different from the second functional additive, or the first functional additive is the same as the second functional additive but the first functional additive is entrained with the first polymer in a concentration that is different than a concentration of the second functional additive entrained with the second polymer.

18. A polymer strand of produced by a process of claim 1.
